(19) United States
(12) Patent Application Publication
(10) Pub. No.: US 2016/0044640 A1
(43) Pub. Date: Feb. 11, 2016

(54) Blind Code Allocation Detection

(71) Applicant: TELEFONAKTIEBOLAGET L M ERICSSON (PUBL), Stockholm (SE)

(72) Inventors: Andres Reial, Malmö (SE); Elias Jonsson, Malmö (SE)

(21) Appl. No.: 14/781,861

(22) PCT Filed: Mar. 27, 2014
(86) PCT No.: PCT/EP2014/056186

§ 371 Date: Oct. 1, 2015

(30) Foreign Application Priority Data
Apr. 4, 2013 (EP) 13162332.4

(51) Int. Cl. H04W 72/04; H04L 5/00; H04W 28/02; H04W 28/08; H04L 1/00; H04W 74/04

(52) U.S. Cl. CPC H04W 72/042; H04L 1/0038; H04W 74/04; H04W 28/0231; H04W 28/08; H04L 1/0014; H04L 5/0083

(57) ABSTRACT

There is provided blind code allocation detection. A method performed in a user equipment comprises receiving a downlink interference signal. The downlink interference signal comprises at least two transmission resource units. Metric vectors are formed for the at least two transmission resource units based on symbol estimates in the transmission resource units. Groups of jointly scheduled transmission resource units are detected based on the metric vectors. A corresponding user equipment, computer program and computer program product are also disclosed.

### TECHNICAL FIELD

Embodiments presented herein relate to blind code detection, and particularly to methods for blind code allocation detection performed in a user equipment, a corresponding user equipment, computer program, and computer program product.

### BACKGROUND

In cellular communication networks, there is always a challenge to obtain good performance and capacity for a given communications protocol, its parameters and the physical environment in which the cellular communication network is deployed.

In cellular communication networks a wireless device (for example a user equipment) establishes a communications link to a network node (for example an evolved Node B) of a cell. Transmissions from other network nodes in other cells of the cellular communication network may by the wireless device be perceived as interference. Interference is in the wireless device mitigated by having a receiver arranged to perform interference cancellation (IC). In traditional receivers performing IC of transmissions from network nodes in other cells, it is necessary for the receiver to have access to configuration information of the interfering network node(s)′ transmission signal(s) in order for the receiver to perform demodulation, decoding, and regeneration.

In general, this information could be obtained by accessing the interfering network node(s)′ control channels or by receiving assistance information from the cellular communication network. In High-Speed Downlink Packet Access (HSDPA), network assistance is not available. Thus a receiver performing IC may attempt eavesdropping the associated High Speed-Shared Control Channel (HS-SCCH) to obtain the Modulation and Coding Scheme (MCS) information.

In some cases, information provided by such a control channel may not be available. Further, decoding may not be possible due to the lack of, for example, transport format information. In such or similar cases, the receiver may be configured to perform a simpler from of IC, where the demodulated symbols are immediately used to regenerate soft symbol estimates to be used for IC. Since decoding is omitted in this approach, it is referred to as pre-decoding IC.

While pre-decoding IC does not require transport format information, modulation-related parameters are still necessary for demodulation. The modulation-related parameters must be detected from the data signal received by the wireless device. In particular, modulation format information is indispensable to configure the demodulation and to estimate the associated signal parameters, e.g. signal scaling and noise power/symbol signal to interference and noise ratio (SINR). In so-called multi-antenna configurations, rank and pre-coding parameters may also be required.

In general terms, code allocation information may not be necessary for pre-decoding IC since cancellation may be applied on a per-code basis. Such a scenario would thus require blind transmission format detection. The performance of blind transmission format detection (as well as subsequent parameter estimation) may be improved if the sample size is increased by including all codes scheduled to the given interfering network node. Code allocation information may also be useful for reducing the complexity of blind detection of the identity of the wireless terminal.

Blind modulation transmission format detection approaches may not provide reliable results at low symbol SINR operating points, typical for IC of transmissions from other cells. For example, classical modulation detection approaches return a decision indicating the highest available modulation order, regardless of the actual transmitted format.

Hence, there is still a need for improved and robust blind code allocation and transmission format detection.

### SUMMARY

An object of embodiments herein is to provide improved and robust blind code allocation and transmission format detection.

The inventors of the enclosed embodiments have realized that the reliability and quality of modulation detection and other transmission format detection, as well as the reliability and quality of subsequent parameter estimation, is limited by the available sample size. In HSDPA per-code processing, it is limited to 480 symbols per estimation instance. The inventors of the enclosed embodiments have therefore realized that if the sample size could be increased, the detection performance as well as the estimation performance could be improved. The inventors of the enclosed embodiments have further realized that one approach for code allocation detection by attempting to detect power differences between adjacent codes is not expected to provide robust results at low SINR.

A particular object is therefore to provide improved and robust blind code allocation and transmission format detection suitable for HSDPA as well as for long-term evolution (LTE) compliant cellular communication networks.

According to a first aspect there is presented a method for blind code allocation detection. The method is performed in a user equipment. The method comprises receiving a downlink interference signal, the downlink interference signal comprising at least two transmission resource units. The method comprises forming metric vectors for the at least two transmission resource units based on symbol estimates in the transmission resource units. The method comprises detecting groups of jointly scheduled transmission resource units based on the metric vectors.

Advantageously the method enables robust blind detection of code allocation (in HSDPA) as well as robust blind detection of resource block allocation (in LTE). This may facilitate subsequent detection of the transmission format elements, e.g. modulation. The information provided by the method may be used e.g. for setting up demodulation in a pre-decoding IC receiver or for providing assistance information to a blind UE ID detection algorithm in a post-decoding IC receiver.

According to embodiments the method comprises detecting transmission format parameters for the groups of jointly scheduled transmission resource units based on the symbol estimates in the groups of jointly scheduled transmission resource units. Advantageously this enables combined blind code allocation and transmission format parameter detection. The metric vectors may comprise initial estimates of transmission format parameters. According to embodiments detecting transmission format parameters is performed only when the initial estimates do not fulfil a quality criterion.

According to a second aspect there is presented a user equipment for blind code allocation and transmission format detection. The user equipment comprises a receiver. The receiver is arranged to receive a downlink interference signal, the downlink interference signal comprising at least two transmission resource units. The user equipment comprises a processing unit arranged to form metric vectors for the at least two transmission resource units based on symbol estimates in the transmission resource units. The processing unit is further arranged to detect groups of jointly scheduled transmission resource units based on the metric vectors.

According to a third aspect there is presented a computer program for blind code allocation detection, the computer program comprising computer program code which, when run on a user equipment, causes the user equipment to perform a method according to the first aspect.

According to a fourth aspect there is presented a computer program product comprising a computer program according to the third aspect and a computer readable means on which the computer program is stored. The computer readable means may be non-volatile computer readable means.

It is to be noted that any feature of the first, second, third and fourth aspects may be applied to any other aspect, wherever appropriate. Likewise, any advantage of the first aspect may equally apply to the second, third, and/or fourth aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating a cellular communication network where embodiments presented herein may be applied;

FIG. 2 is a schematic diagram showing functional modules of a user equipment;

FIG. 3 shows one example of a computer program product comprising computer readable means;

FIGS. 4 and 5 are flowcharts of methods according to embodiments; and

FIGS. 6 and 7 schematically illustrate I/Q diagrams.

### DETAILED DESCRIPTION

The inventive concept will now be described more fully hereinafter with reference to the accompanying drawings, in which certain embodiments of the invention are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description.

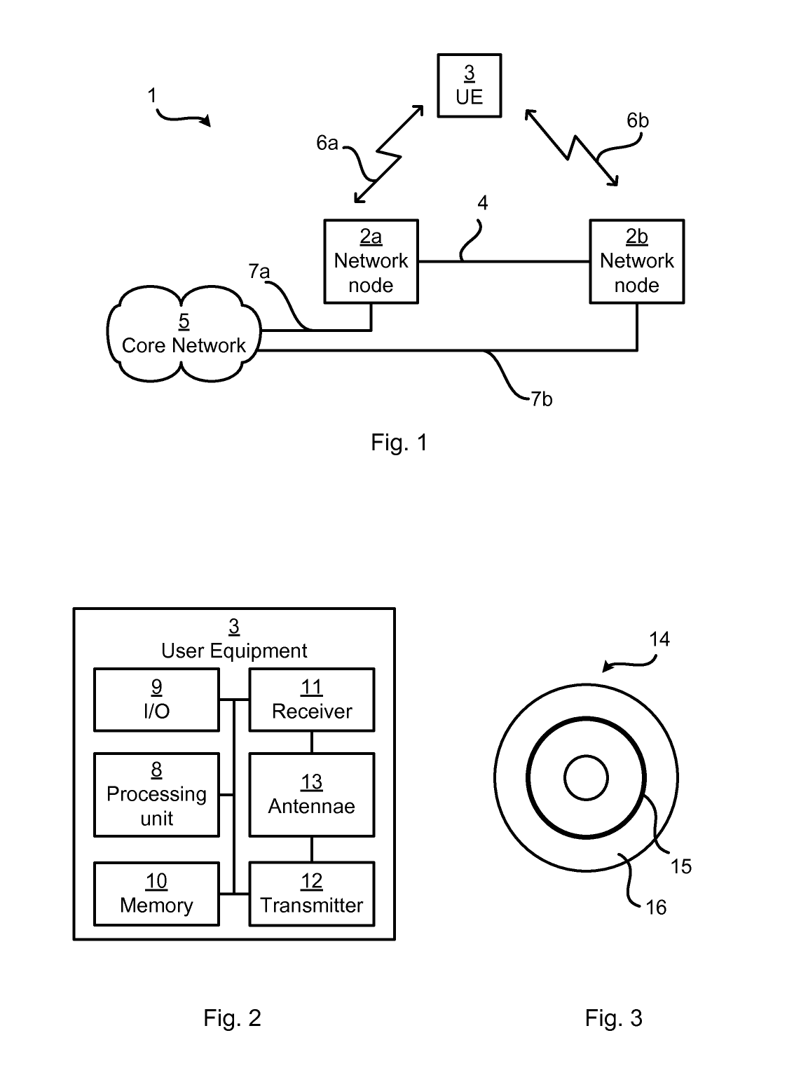

FIG. 1 is a schematic diagram illustrating a cellular communication network 1 where embodiments presented herein can be applied. The cellular communications network 1 comprises network nodes 2a, 2b and a wireless device, hereinafter referred to as a user equipment (UE)₃. The network nodes 2a, 2b are base stations to which the UE 3 is arranged to establish a wireless communications link 6a, 6b, in order to access content and services provided by a core network 5. The network nodes 2a, 2b may represent eNodeBs (E-UTRAN NodeB, also known as Evolved NodeB). eNodeBs are typically connected to each other via the so-called X2 interface (as illustrated by reference numeral 4), and they connect to the core network 5 via the so-called Si interface (as illustrated by reference numerals 7a and 7b). The UE 3 may represent a mobile terminal, a user terminal, a user agent, etc. The cellular communication network 1 may generally comply with any one or a combination of W-CDMA (Wideband Code Division Multiplex), LTE (Long Term Evolution), EDGE (Enhanced Data Rates for GSM Evolution, Enhanced GPRS (General Packet Radio Service)), CDMA2000 (Code Division Multiple Access 2000), etc., as long as the principles described hereinafter are applicable. Typically the cellular communication network 1 is arranged such that each network node 2a, 2b serves the UE 3 on a per cell basis. Once the UE 3 has established a wireless communications link 6a to one network node 2a, signals transmitted from another network node 2b as received by the UE 3 on another wireless communications link 6b may be regarded as interference.

For HSDPA, a new transport layer channel, High-Speed Downlink Shared Channel (HS-DSCH), has been added to UMTS release 5 and further specification. It is implemented by introducing three new physical layer channels: HS-SCCH, HS-DPCCH and HS-PDSCH. The High Speed-Shared Control Channel (HS-SCCH) informs the UE 3 that data will be sent on the HS-DSCH, 2 slots ahead. The Uplink High Speed-Dedicated Physical Control Channel (HS-DPCCH) carries acknowledgment information and current channel quality indicator (CQI) of the UE 3. This value is then used by the network node 2a, 2b to calculate how much data to send to the UE 3 on the next transmission. The High Speed-Physical Downlink Shared Channel (HS-PDSCH) is the channel mapped to the above HS-DSCH transport channel that carries actual user data. The embodiments disclosed herein relate to blind code allocation detection; for example to code allocation detection in HSDPA without access to the HS-SCCH information. In general terms in order to perform pre-decoding IC in HSDPA without access to the HS-SCCH information, transmission format (modulation format, multi-antenna configuration, etc.) information and preferably the HS-PDSCH code allocation to a given user equipment must be detected directly from the received data channel. The herein disclosed embodiments provide a robust approach for performing such detection. Particularly, in order to obtain blind code allocation detection there is provided a UE 3, a method performed in the UE 3, a computer program 15 comprising code, for example in the form of a computer program product 14, that when run on the UE 3, causes the UE 3 to perform the method.

FIG. 2 schematically illustrates, in terms of a number of functional modules, the components of a UE 3. A processing unit 8 is provided using any combination of one or more of a suitable central processing unit (CPU), multiprocessor, microcontroller, digital signal processor (DSP), application specific integrated circuit (ASIC) etc., capable of executing software instructions stored in a computer program product 14 (as in FIG. 3), e.g. in the form of a memory to. Thus the processing unit 8 is thereby arranged to execute methods as herein disclosed. The memory to may also comprise persistent storage, which, for example, can be any single one or combination of magnetic memory, optical memory, solid state memory or even remotely mounted memory. The UE 3 may further comprise an input/output (I/O) interface 9 for receiving and providing information to a user interface. The UE 3 also comprises one or more transmitters 12 and receivers 11, comprising analogue and digital components forming the functionalities of a transmitter and a receiver, and a suitable number of antennae 13 for radio communication with the network nodes 2a, 2b. The processing unit 8 controls the general operation of the UE 3, e.g. by sending control signals to the I/O interface 9, the memory 10, the transmitter 12 and/or the receiver 11 and receiving reports and information from the I/O interface 9, the memory 10, the transmitter 12 and/or the receiver 11 of its operation. Other components, as well as the related functionality, of the UE 3 are omitted in order not to obscure the concepts presented herein.

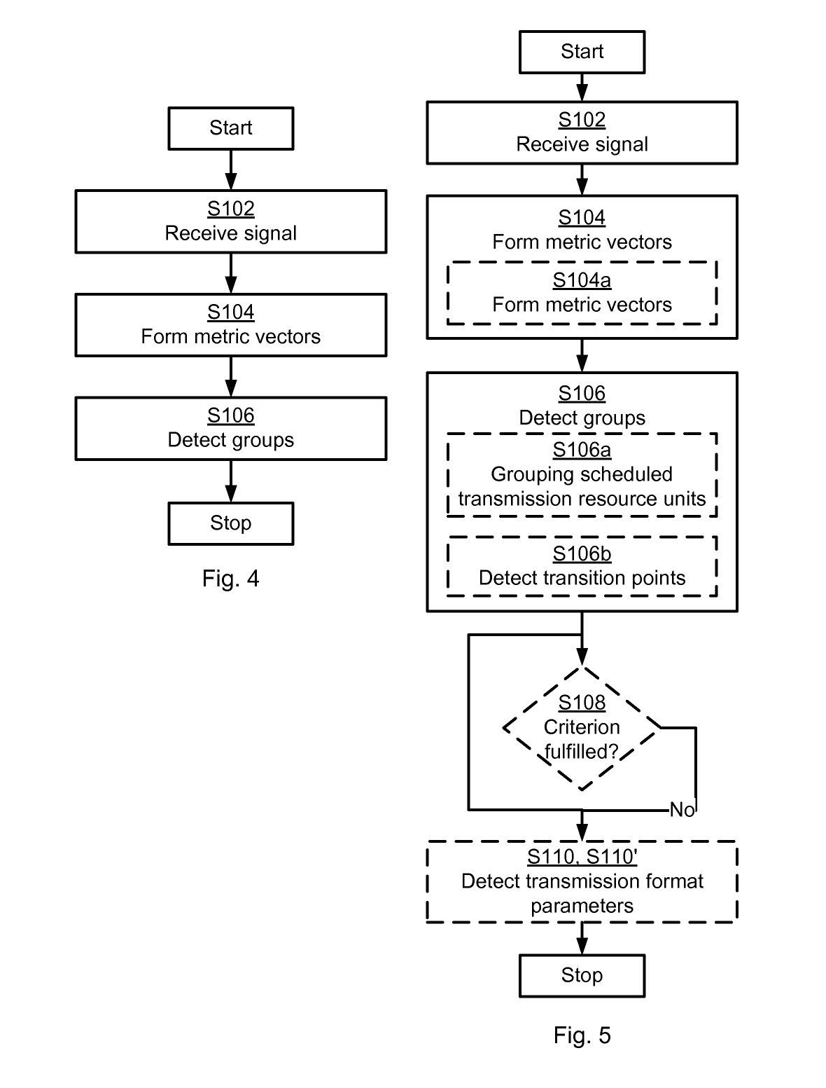

FIGS. 4 and 5 are flow charts illustrating embodiments of methods for blind code allocation detection. The methods are performed in the UE 3. The methods are advantageously provided as computer programs 15. FIG. 3 shows one example of a computer program product 14 comprising computer readable means 16. On this computer readable means 16, a computer program 15 can be stored, which computer program 15 can cause the processing unit 8 and thereto operatively coupled entities and devices, such as the memory 10, the I/O interface 9, the transmitter 12, the receiver 11 and/or the antennae 13 to execute methods according to embodiments described herein. In the example of FIG. 3, the computer program product 14 is illustrated as an optical disc, such as a CD (compact disc) or a DVD (digital versatile disc) or a Blu-Ray disc. The computer program product could also be embodied as a memory (RAM, ROM, EPROM, EEPROM) and more particularly as a non-volatile storage medium of a device in an external memory such as a USB (Universal Serial Bus) memory. Particularly, the computer program 15 may be stored in the memory 10 of the UE 3 and thereby enable the UE 3 to perform methods as herein described. Thus, while the computer program 15 is here schematically shown as a track on the depicted optical disk, the computer program 15 can be stored in any way which is suitable for the computer program product 14.

Returning now to FIG. 1, a method for blind code allocation detection comprises, in a step S102, receiving a downlink interference signal. The downlink interference signal is received by the receiver 11 of the UE 3. The downlink interference signal comprises at least two transmission resource units. The transmission resource unit may be a HS-PDSCH code in HSDPA (i.e., a High-Speed Downlink Packet Access High Speed-Physical Downlink Shared Channel code). Alternatively the transmission resource unit may be a resource block (RB) in LTE (Long-Term Evolution). As noted above, in FIG. 1, signals transmitted by the network node 2b on the wireless communications link 6b may by the UE 3 be regarded as interference (assuming that the UE 3 has an established wireless communications link 6a with the network node 2a).

### Code Metrics

Next, metrics are determined on a per-code basis. Particularly, the processing unit 8 of the UE 3 is arranged to, in a step S104, form metric vectors for the at least two transmission resource units based on symbol estimates in the transmission resource units.

In general terms, for each code k, at least one metric values qₗ^{(k)} may be determined to form a metric vector q^{(k)} with elements l=1 . . . L, based on the symbol estimates sₖ(i) from that code. Further, in general terms, the choice of the metric values qₗ^{(k)} may be implementation-specific. According to some embodiments, associated with the set of metric vectors q^{(k)} may be a common weighting vector w that provides reliability and/or importance information for the individual metric values. The weighting elements may be formed as

$${w}_{l} = \frac{{a}_{l}}{{σ}_{l}^{2}}$$

where σₗ² is the current estimation error variance for metric value l and aᵢ is a pre-determined constant, based on and defined at the time of metric design. That is, according to an embodiment the processing unit 8 is arranged to, in an optional sub-step S104a, form the symbol estimates by combining individual per-antenna and/or per-delay symbol estimates after frequency transformation (for example by applying a Fast Fourier Transform, FFT in LTE) or despreading (in HSDPA) of the transmission resource units. This would enable improved and accurate forming of the symbol estimates.

The metric values may represent at least one of the following: initial estimates of signal power (or other moments), initial estimates of “unitless” statistical metrics (e.g. excess kurtosis, histogram, and/or probability density function), initial modulation estimates, initial rank or precoding estimates, per-dimension magnitude or power histogram bins, etc. That is, according to embodiments the metric vectors are indicative of at least one of received signal power, initial modulation, signal distribution, and estimates of higher-order statistics of the symbol estimates. Also according to embodiments the transmission format itself may be indicative of at least one of modulation, rank, and pre-coding of the received downlink interference signal. As the skilled person understands, each of these parameters has its advantages.

According to some embodiments, several types of metric values are mixed to obtain a robust “signature” for the individual codes via the metric vector(s). Different types of metric values may be useful for discriminating the individual code properties. The metric vector(s) may therefore contain metric values which are sensitive to different operating points and conditions. However, each metric vector as a whole need not provide useful information for the following demodulation, as long as one or more of its dimensions provide a “signature” discrimination function. That is, according to an embodiment the UE 3 is arranged to, in an optional sub-step, form the metric vectors such that at least one of its dimensions provide a signature discrimination function for each individual transmission resource unit of the at least two transmission resource units.

According to some embodiments, denoising of the metric values may be applied to improve the metric vector quality.

### Code Groupings Detection

Next, code groupings are detected. Particularly, the processing unit 8 of the UE 3 is arranged to, in a step S106, detect groups of jointly scheduled transmission resource units based on the metric vectors. In general terms, the metric vectors for the codes belonging to the same UE 3 should be “similar” (as determined e.g. by a distance criterion, such as Hamming distance, Euclidean distance, etc.), while the vectors describing codes to different UEs should not be “similar”, due to the differences in power allocation and modulation as well as other transmission format settings. Consider now HSDPA. In general terms, the HS-DSCH downlink channel is shared between UEs using channel-dependent scheduling to make the best use of available radio conditions. Each UE continually transmits an indication of the downlink signal quality. Using this information from all UEs operatively connected to the network node, the network node decides which UEs will be sent data in the next frame and how much data should be sent for each UE. The allocation is in units of channelisation codes for Spreading Factor 16 (SF16), of which 16 exist and up to 15 can be allocated to the HS-DSCH. Therefore, since the HS-PDSCH code allocation for a given UE is contiguous, and the scheduler typically attempts to allocate the individual UEs next to each other in the SF16 code space, the metric vectors should exhibit a discernible difference (according to some measure) at the code transition point, where the code allocation for one UE ends and another begins. That is, according to an embodiment the processing unit 8 is arranged to, in an optional sub-step S106a, group scheduled transmission resource units that belong to the same UE 3 by detecting transition points for transmission resource unit allocation where contiguous allocation for one UE ends and contiguous allocation for a next UE begins.

According to some embodiments, the code transition point may be detected by observing a “1-D” metric vector sequence. In some of such embodiments, for each adjacent code pair k and k−1, the difference measure may be defined e.g. as d_{k,k-1}=w^{T}|q^{(k)}−q^{(k-1)}|. According to such embodiments detection of transition points thus basically amounts to detecting large changes in the metric vector: the transition point at code k is detected if the difference measure exceeds a threshold, d_{k,k-1}>τ. The threshold may be predetermined or based on the values of d_{k,k-1} for all values of k (min, max, mean, etc.). Instead of a linear (e.g. Euclidean) distance measure, other measures could be used, such as, but not limited to: squared distance, metric vector correlation c_{k,k-1}=|(Wq^{(k)})^{H}(Wq^{(k-1)}| (where W is a diagonal matrix with diagonal elements wₗ), and other related constructions.

According to other embodiments, the code transition point may be detected by analyzing “2-D” characteristics of the metric vector relationships. In some of such embodiments, a metric vector distance matrix D is formed with elements d_{k,n}=w^{T}|q^{(k)}−q⁽ⁿ⁾| for all possible SF16 codes used for HS-PDSCH: k=2 . . . 16, n=2 . . . 16. The resulting matrix has block diagonal sections with low values and off-diagonal sections with higher values. However, even the distance properties between different code allocations are consistent for a given code allocation pair. In general terms the edge detection operation may be performed over entire rows (or columns) in the matrix D to obtain more robust results,

$${δ}_{k , k - 1} = {\sum }_{n = 2}^{16} \vert {d}_{k , n} - {d}_{k - 1 , n} \vert .$$

As above, the transition point at code k is detected if the difference measure exceeds a threshold, δ_{k,k-1}>τ. Again, other distance measures could be used. (If correlation measures would be used to form the matrix, as shown above, the block diagonal sections would contain larger entries.)

That is, the processing unit 8 may be arranged to, in an optional sub-step S106b, detect the transition points for transmission resource unit allocation based on 1-dimensional (1-D) or 2-dimensional (2-D) edge detection, wherein the edge detection is applied as at least one of a difference measure, a distance measure, or a correlation measure between the metric vectors.

According to yet other embodiments, 1-D or 2-D hypothesis testing may be used instead of edge detection to identify groups of codes, the minimized aggregate intra-group metric differences and maximizing inter-group differences.

The detected code allocation transition points are then used to define the contiguous per-user code groups.

### Transmission Format Parameter Detection

Next, transmission format parameters may be detected. The per-used code groups are subsequently used to perform blind modulation detection, and possibly detection of other transmission format parameters. Particularly, the processing unit 8 of the UE 3 may be arranged to, in an optional step Silo, detect transmission format parameters for the groups of jointly scheduled transmission resource units. The detection is based on the symbol estimates in the groups of jointly scheduled transmission resource units. Some non-limiting approaches to modulation detection are provided below with reference to Scenario 1. The herein disclosed blind detection quality is improved over per-code detection, due to a larger sample size. In a typical scheduling pattern, when 14 codes are scheduled to a given UE, the sample size is increased by more than an order of magnitude.

The metric vectors may comprise initial estimates of transmission format parameters. If such initial modulation estimates are included in the per-code metric vector, and if they are deemed sufficiently reliable, e.g. when operation at high SINR, the step Silo of re-detecting modulation may be omitted. That is, according to embodiments the initial estimates of transmission format parameters are, in an option sub-step S108, and by the processing unit 8, compared to a quality criterion. The processing unit 8 may then be arranged to, in an optional sub-step Silo′, only detect the transmission format parameters for the groups of jointly scheduled transmission resource units based on the symbol estimates in the groups of jointly scheduled transmission resource units when the initial estimates do not fulfil the quality criterion. The grouping information may further be used for robust demodulation parameter estimation (e.g. constellation scaling and/or symbol SINR).

Two non-limiting scenarios where the above disclosed embodiments may be readily applied will be disclosed next. However, as the skilled person understands, these are just two of many scenarios where the above disclosed embodiments may be readily applied. Unless otherwise stated, each step of each scenario is performed by the processing unit 8. The steps may be defined and implemented as computer program portions. Thus, also the subject matter defined by the below disclosed first and/or second scenario may be enclosed in the above recited computer program 15 and computer program product 14 and be accessed and executed by the processing unit 8.

### Scenario 1

In this scenario only the combined symbols for each of the spreading factor 16 codes 1 to 15 from an interfering cell are used as input. Further, this scenario is based on the interfering cell using all or a sub-set of these codes for HS-PDSCH transmission. If only a sub-set of the 15 codes are used, the remaining codes are assumed to be empty. This approach is robust even if codes not used for HS-PDSCH are used for other purposes, such as a DPCH transmission. This scenario is further based on that in a HS-PDSCH transmission the modulation and power is the same for all codes transmitted to a given UE.

For a HS-PDSCH, and transmitted on channelization code k, the average amplitude over a Transmission Time Interval (TTI) of combiner output symbols is determined as

$${d}^{( k )} ( {n}_{TTI} ) = \frac{1}{3 \times 160} {\sum }_{i = 0}^{479} ( \vert Re {s}_{k} ( i ) \vert + \vert Im {s}_{k} ( i ) \vert ) \qquad ( 1 )$$

Here, the index i is enumerating the symbols in time, n_{TTI} is the TTI number, and sₖ(i) is the Combiner output for code k and symbol index i in the TTI.

As noted above, combined symbols for HS-PDSCH codes 1 to 15 from an interfering cell is used as input. As output is produced the codes of the same power and a suggested common modulation is output for each group of codes. The maximum number of UEs being simultaneously addressed in a TTI is used as a parameter.

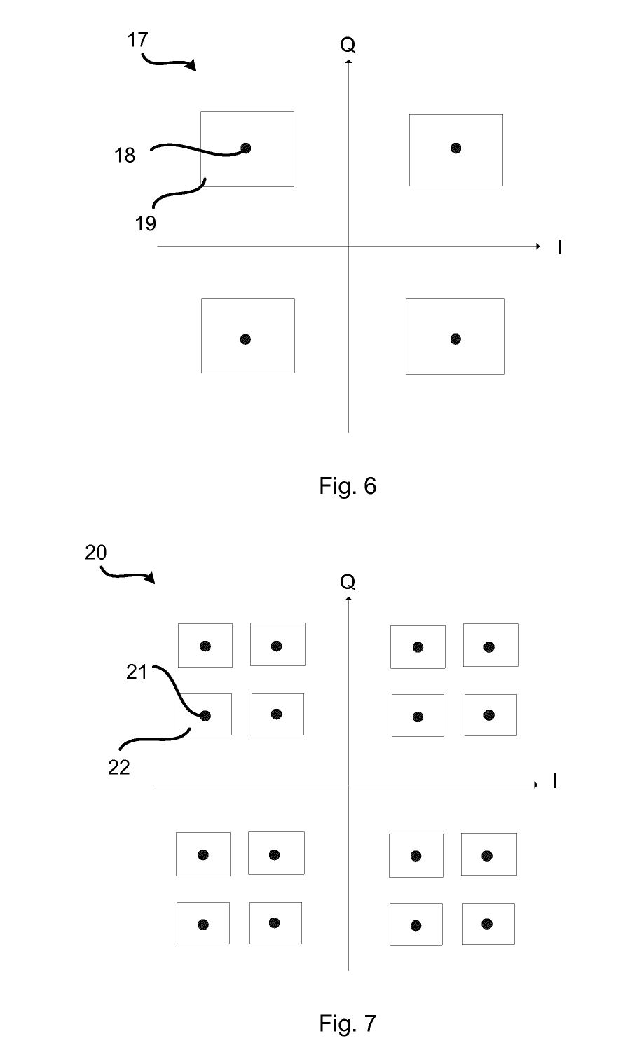

Step 1.1 involves coarse metric calculation for the likelihood that a given modulation has been used. First the amplitude is estimated, for example, using equation (1) of the real or imaginary part of the combined symbols for a given code. This is used to locate where the constellation points are in the I/Q (in-phase and quadrature) diagram. FIGS. 6 and 7 schematically illustrate two example of I/Q diagrams 17, 20; FIG. 6 is an I/Q diagram 17 for quadrature phase shift keying, QPSK, (or 4 quadrature amplitude modulation, 4-QAM) and FIG. 7 is an I/Q diagram 20 for 16-QAM. In FIGS. 6 and 7 the black circles denote constellation points 18, 21. Areas 19, 22 in which each constellation point is a midpoint are then defined. In FIGS. 6 and 7 these areas are illustrated as rectangles. However, as the skilled person understands, the areas may be circular shaped, diamond shaped, etc. The total area of the defined area is the same for no modulation (i.e., empty code), QPSK, 16-QAM, and 64-QAM. The areas can be divided into groups, where each group contains 4 sub-areas. For no modulation, empty code, only one group with one element exists; for QPSK only one group exists; there are 4 groups for 16-QAM; and 16 groups for 64-QAM. Each element in a group overlaps in the same manner constellation points for a constellation not given by the one constellation point the group belongs to. That is, the same symmetry is found between elements in a group and how they overlap with constellation points for all modulation formats. For a given modulation, mod=0,1,2,3 (no transmission, QPSK, 16-QAM, 64-QAM) let μ_{mod,g}^{(k)} be the ratio of elements belonging to group g. If the assumed constellation agrees with the transmitted constellation, all the μ_{mod,g}^{(k)} should be of the same size. Also denote by μ_{mod,outside}^{(k)} the ratio of points not belonging to any area. The size of μ_{mod,outside}^{(k)} will depend on the amount of noise, but will be smaller for the case the assumed modulation agrees with the transmitted modulation.

The composite metric for the modulation are then defined as μ_{mod}^{(k)}, where mod=0,1,2,3, as:

$${μ}_{mod}^{( k )} = {γ}_{1} {\sum }_{⋁ {g}_{1} \neq {g}_{2}} {( {μ}_{mod , {g}_{1}}^{( k )} - {μ}_{mod , {g}_{2}}^{( k )} )}^{2} + {γ}_{2} \cdot {μ}_{mod , outside}^{( k )}$$

Here, the parameters γ₁ and γ₂ are weighting factures which may be used to put more or less emphasis on the first term or the second term. Typically, γ₁ and γ₂ are of equal weight.

The size of the areas could depend on the measured signal to noise ratio (SNR). In general terms, the areas increase with the noise level. This provides improved discrimination power from the ratio between elements inside and outside the areas.

Step 1.2 involves denoising of the metric values by denoising the amplitude estimates d^{(k)}(n_{TTI}) and the modulation metrics μ_{mod}^{(k)}. Hereinafter the TTI index will be omitted, since it is of no importance to the algorithm under consideration. Denoising is accomplished by finding \tilde{d}^{(k)} which minimizes

$${α}_{1} {\sum }_{k = 2}^{15} \vert {\tilde{d}}^{( k )} - {\tilde{d}}^{( k - 1 )} \vert + {α}_{2} {\sum }_{k = 1}^{15} {\vert {\tilde{d}}^{( k )} - {d}^{( k )} \vert}^{2} \qquad ( 2 )$$

and by finding \tilde{μ}_{mod}^{(k)} which minimizes

$${α}_{3} {\sum }_{k = 2}^{15} \vert {\tilde{μ}}_{mod}^{( k )} - {\tilde{μ}}_{mod}^{( k - 1 )} \vert + {α}_{4} {\sum }_{k = 1}^{15} {\vert {\tilde{μ}}_{mod}^{( k )} - {μ}_{mod}^{( k )} \vert}^{2} \qquad ( 3 )$$

Here, αᵢ are constants to be tuned. One reason for using the L1 norm in the first term, the regularization term, is that by using the L1 norm edges are preserved. That is, a drop from a high value from one code to the next is preserved. With an L2 norm in the regularization term there may be unnecessary smoothing of the edges.

Here, α₂ and α₄ can be set to one, i.e., α₂=α₄=1. The values of α₁ and α₃ may then be found by tuning. Typically the values of α₁ and α₃ would be of the order of 0.01-0.1 and could depend on the signal to noise ratio. There are many ways to solve for \tilde{d}^{(k)} in equation (2). One way is to approximate the L1 one norm with \sqrt{∥²+ε} for some small ε. This makes the expression (2) differentiable and \tilde{d}^{(k)} can be solved for by differentiating and setting the derivative to zero, followed by a fix-point method when solving for the zero (in order to find the minimum).

Step 1.3 involves edge detector. Points/codes with k are found such that

|\tilde{d}^{(k)}−\tilde{d}^{(k-1)}|>τ₁·max_{iε[1,15]}(|\tilde{d}⁽ⁱ⁾|) and max(\tilde{d}^{(k)},\tilde{d}^{(k-1)})≧τ₃ (4)

or

|\tilde{μ}_{mod}^{(k)}−\tilde{μ}_{mod}^{(k-1)}|<τ₂·max_{iε[1,15]}(|μ_{mod}^{(u)}|) and max(\tilde{μ}_{mod}^{(k)},\tilde{μ}_{mod}^{(k-1)})≦τ₄ (5)

In equations (4) above, the last factor in the RHS (max_{iε[1,15]}(|\tilde{d}⁽ⁱ⁾|) or max_{iε[1,15]}(|μ_{mod}⁽ⁱ⁾|)) is present to normalize the selection of points. By means of the second inequality in equations (4) and (5) recording points/codes where both codes involved are either unused or the wrong modulation hypotheses is assumed is avoided. Triggering on noise is thereby avoided.

One purpose of equation (4) or (5) is to identify possible edges, that is, changes in transmit power or modulation. Changes in transmit power could occur because different UEs are addressed or because of empty codes.

Here, τᵢ are tuned to strike a balance between detecting true edges and avoiding false detections. The higher the τᵢ values the less number of edges will be found. It is a possible outcome that no edges are found. Here, τ₁ and τ₂ are typically of the order of 0.2-0.5 and τ₃ of the order of 0.1 and τ₄ of the order of 0.1, assuming the UE receiver 11 is arranged to normalize the incoming signal to a value of one. For a more elaborate tuning the τ₁ values could depend on the signal to noise ratio, SNR.

Equation (4) produces a set of codes where the transmit power changes from one code to the next and equation (5) produces a set of codes for each modulation hypothesis where the modulation changes from one code to the next. At this stage the transmit power changes are said to be well defined.

Step 1.4 involves modulation selection fine tuning. Denote by the set J all codes (edges) selected by the modulation criteria, that is, equation (4) above, which indicates a possible change of modulation across codes. Now select all combinations of 0, . . . N_{edge} points from the set J. Here, the value of N_{edge} depends on the assumed maximum number of simultaneously transmitting UEs, for example, if at most one UE is assumed, N_{edge} equals to 2; if at most two UEs are assumed N_{edge} equals 4. That is, N_{edge} equals twice the assumed number of maximum simultaneously transmitting UEs per TTI. For each such set of points, intervals Iₙ, n=1, . . . , N whose endpoints coincide with a given subset of J are defined. In each interval the modulation is selected as the one that minimizes μ̅_{mod}⁽ⁿ⁾, that is, the average of the \tilde{μ}_{mod}^{(k)} within the interval Iₙ for the modulation given by mod.

Next, the metric of equation (6) is evaluated:

$${\sum }_{n = 1}^{N} {\overline{μ}}_{mod}^{( n )} \qquad ( 6 )$$

The metric of equation (6) is evaluated for all sets of at most N_{edge} points and the final selection of points where the modulation changes and its corresponding modulation in each interval is given by the combination that minimizes the metric in equation (6).

By letting the metric vector q^{(k)} be defined as q^{(k)}=(d^{(k)},μ_{mod}^{(k)}) Step 1.1 of the present scenario thus corresponds to step 104. Further, Steps 1.2 and 1.3 thereby correspond to step 106, and Step 1.4 corresponds to step Silo. Hence, the subject matter of Steps 1.1-1.4 may be readily combined and integrated with the above.

### Scenario 2

Step 2.1 involves scaling all codes with a common scale factor. The common scale factor may be chosen so that the code with the highest power is normalized to unit power.

Step 2.2 involves estimating statistics of the codes. For each code k=1 to 15, two sub-steps are performed. Firstly, the QAM symbols are separated into real and imaginary Pulse Amplitude Modulation (PAM) components. Secondly, the PDF (as represented by a histogram) is estimated of all PAM symbols over a fixed support (denoted by q^{(k)}, a column vector).

Step 2.3 involves determining correlation coefficients of the histograms for each code pair {k,n}:

$${c}_{k , n} = \frac{{q}^{{( k )}^{T}} {q}^{( n )}}{\sqrt{{q}^{{( k )}^{T}} {q}^{( k )} {q}^{{( n )}^{T}} {q}^{( n )}}} = \frac{{\sum }_{l = 1}^{L} {q}_{l}^{( k )} {q}_{l}^{( n )}}{\sqrt{( {\sum }_{l = 1}^{L} {q}_{l}^{( k )} {q}_{l}^{( k )} ) ( {\sum }_{l = 1}^{L} {q}_{l}^{( n )} {q}_{l}^{( n )} )}} ,$$

where qᵢ^{(k)} is the histogram count for code k and bin l. The expression for c_{k,n} includes normalization of correlation values to the range [0, . . . , 1].

Alternatively, the normalized difference between the histograms may be used. Thus, c_{k,n} may be determined according to:

$${c}_{k , n} = \frac{{\sum }_{l = 1}^{N} \vert {q}_{l}^{( k )} - {q}_{l}^{( n )} \vert}{{\sum }_{l = 1}^{N} {q}_{l}^{( k )}}$$

Step 2.4 involves code group detection and comprises detecting one or more Mock-diagonal sub-matrices in a matrix C, built from the terms c_{k,n}.

Detecting the block boundaries may be accomplished using per-row edge detection. The code transition metric for each row is determined as

$${δ}_{k , k - 1} = {\sum }_{n = 2}^{N + 1} \vert {c}_{k , n} - {c}_{k - 1 , n} \vert , N = 15$$

and for rows where the metric exceeds a threshold, δ_{k,k-1}>τ, where τ is determined experimentally for different received signal SINR values, a code group boundary is detected.

An alternative way of detecting code group boundary is to first denoise the correlation values per column (as in Step 1.2 above), then proceeding through the rows starting from the first diagonal element of the denoised C matrix so as to detect the first edge as in equation (4) above, then proceeding to the diagonal element pointed by the row where the first edge was detected, then proceeding further through the rows until a further edge is detected, and so on.

At high SINR, typically all matrix entries in diagonal blocks (with same power and modulation across the codes) have values equal to one and all the rest of the matrix entries in C would be close to zero. At low SINRs, intermediate values will also occur, but the diagonal blocks still have the largest magnitude, with values close to one.

Once the groups are known, modulation and other transmission parameters are detected for each group, using symbols from all codes in a given group. Such detection is as such known in the art and further elaboration regarding the same is therefore omitted.

In summary, according to the inventive concept presented herein, code allocation (and optionally also transmission format) is detected blindly using a sequence of operations. For example, the inventive concept presented herein enables interference cancellation in HSDPA as well as in LTE without access to HS-SCCH (in HSDPA) or RB (in LTE) information, and without decoding of the received data channel, as defined by the received downlink interference signal. For each data code, a metric vector is formulated, based on its symbol estimates. The metric vectors may reflect one or more of received signal power, initial modulation and other transmission format estimates, signal distribution (e.g. magnitude histogram, PDF, “unit-less” higher-order statistics such as kurtosis), etc. The metric vectors constitute (soft) “signatures” for the different codes, without requiring explicit decisions about their signal structure. Code grouping is detected, based on analyzing relationships between the per-code metric vectors. The relationships may be formulated in terms of differences, Euclidean or squared distances, or correlations between the different per-code metric vectors. Since the code allocation groups are contiguous, edge detection principles may be used to detect transitions from one code group to the next. Edge detection may be applied in 1-D (metric relationships between adjacent codes) or in 2-D (metric relationships between all code pairs). Symbols from the entire detected code group(s) may be used to estimate transmission format settings (e.g. modulation, rank, and pre-coding), utilizing the full per-user sample set. The grouping information may further be used to make the demodulation parameter estimation (e.g. constellation scaling and/or symbol SINR) more robust.

The inventive concept has mainly been described above with reference to a few embodiments. However, as is readily appreciated by a person skilled in the art, other embodiments than the ones disclosed above are equally possible within the scope of the inventive concept, as defined by the appended patent claims. For example, although the inventive concept in some embodiments has been described in terms of forming and operating on metric vectors containing all “signature” information, alternative but essentially equivalent embodiments exist where the different metric values are handled (reformulated in terms of vector operations) one by one in the code group boundary process.

Further, the inventive concept may be readily applied in a multiple input multiple output (MIMO) reception/transmission context. One difference is that for MIMO more metrics need to be evaluated. For example, with reference to Scenario 1, Steps 1.1 to 1.4 generally need to be performed for each input stream and for each hypothesis of the rank. Since the pre-coder used is unknown, all pre-coders need to be considered for each rank. The pre-coder hypothesis giving the smallest value in equation (6) is the one assumed is being transmitted from the interfering cell.

Further, although the inventive concept mainly has been described in the context of HSDPA, similar blind modulation and symbol grouping detection problems arise in e.g. LTE, where several resource blocks may carry data for the same user and thus share similar modulation parameters. As noted above, for an LTE context the codes are in the above embodiments and scenarios replaced with resource blocks, mutatis mutandis.

1-15. (canceled)

16. A method for blind code allocation detection, the method being performed in a user equipment, comprising the steps of:
receiving a downlink interference signal, the downlink interference signal comprising at least two transmission resource units;
forming metric vectors for the at least two transmission resource units based on symbol estimates in the transmission resource units; and
detecting groups of jointly scheduled transmission resource units based on the metric vectors.

17. The method according to claim 16, further comprising:
detecting transmission format parameters for the groups of jointly scheduled transmission resource units based on the symbol estimates in said groups of jointly scheduled transmission resource units.

18. The method according to claim 16, wherein said metric vectors comprise initial estimates of transmission format parameters, the method further comprising:
comparing the initial estimates of transmission format parameters to a quality criterion; and
detecting transmission format parameters for the groups of jointly scheduled transmission resource units based on the symbol estimates in said groups of jointly scheduled transmission resource units only when said initial estimates do not fulfil said quality criterion.

19. The method according to claim 16, wherein the metric vectors are indicative of at least one of received signal power, initial modulation, signal distribution, and estimates of higher-order statistics of the symbol estimates.

20. The method according to claim 16, further comprising:
forming said symbol estimates by combining individual per-antenna and/or per-delay symbol estimates after frequency transformation or despreading of the transmission resource units.

21. The method according to claim 16, wherein detecting the groups comprises:
grouping scheduled transmission resource units that belong to the same user equipment by detecting transition points for transmission resource unit allocation where contiguous allocation for one user equipment ends and contiguous allocation for a next user equipment begins.

22. The method according to claim 21, wherein detecting the code allocation transition points comprises:
detecting said transition points for transmission resource unit allocation based on 1-dimensional or 2-dimensional edge detection, wherein the edge detection is applied as at least one of a difference measure, a distance measure, or a correlation measure between the metric vectors.

23. The method according to claim 16, wherein the transmission resource unit is either a High-Speed Downlink Packet Access (HSDPA), High Speed-Physical Downlink Shared Channel (HS-PDSCH) code or a Long-Term Evolution (LTE) resource block (RB).

24. The method according to claim 16, wherein the transmission format is indicative of at least one of modulation, rank, and pre-coding of the received downlink interference signal.

25. A user equipment for blind code allocation and transmission format detection, comprising:
a receiver arranged to receive a downlink interference signal, the downlink interference signal comprising at least two transmission resource units;
a processing circuit arranged to form metric vectors for the at least two transmission resource units based on symbol estimates in the transmission resource units; and
the processing circuit further being arranged to detect groups of jointly scheduled transmission resource units based on the metric vectors.

26. The user equipment according to claim 25, wherein
the processing circuit is further arranged to detect transmission format parameters for the groups of jointly scheduled transmission resource units based on the symbol estimates in said groups of jointly scheduled transmission resource units.

27. The user equipment according to claim 25, wherein said metric vectors comprise initial estimates of transmission format parameters, and wherein
the processing circuit is further arranged to compare the initial estimates of transmission format parameters to a quality criterion; and to
detect transmission format parameters for the groups of jointly scheduled transmission resource units based on the symbol estimates in said groups of jointly scheduled transmission resource units only when said initial estimates do not fulfil said quality criterion.

28. The user equipment according to claim 25, wherein the processing circuit is further arranged to form said metric vectors by combining individual per-antenna or per-delay symbol estimates after frequency transformation or despreading of the transmission resource units.

29. A non-transitory computer-readable medium storing a computer program for blind code allocation, the computer program comprising computer program code that, when executed by a processing circuit in a user equipment, configures the user equipment to:
receive a downlink interference signal, the downlink interference signal comprising at least two transmission resource units;
form metric vectors for the at least two transmission resource units based on symbol estimates in the transmission resource units; and
detect groups of jointly scheduled transmission resource units based on the metric vectors.
